(19) United States
(12) Patent Application Publication
(10) Pub. No.: US 2010/0063662 A1
(43) Pub. Date: Mar. 11, 2010

(54) CONTROL DEVICE AND CONTROL METHOD OF HYBRID VEHICLE

(75) Inventors: Takeshi HARADA, Nagoya-city (JP); Ikuo Ando, Toyota-city (JP); Daigo Ando, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/554,063

(22) Filed: Sep. 4, 2009

(30) Foreign Application Priority Data
Sep. 5, 2008 (JP) 2008-228786

(51) Int. Cl. B60W 10/06; G06F 19/00; B60W 20/00

(52) U.S. Cl. 701/22; 180/65.28; 180/65.21

(57) ABSTRACT

If an ECU of a hybrid vehicle receives an EV request signal from an EV switch, the ECU determines whether an intermittency prohibition operation for emission deterioration prevention is in progress. The EV request signal indicates that a driver requests EV running using only a motor. If the ECU determines that the intermittency prohibition operation for the emission deterioration prevention is in progress, the ECU does not allow the EV running request from the driver but operates the engine continuously. Thus, the emission deterioration of the hybrid vehicle can be inhibited appropriately.

### CROSS REFERENCE TO RELATED APPLICATION

This application is based on and incorporates herein by reference Japanese Patent Application No. 2008-228786 filed on Sep. 5, 2008.

### BACKGROUND OF THE INVENTION

1. Field of the Invention

The present invention relates to a control technology of a hybrid vehicle that uses at least an internal combustion engine as a power source. In particular, the present invention relates to a technology for inhibiting deterioration of emission in exhaust gas of the internal combustion engine.

2. Description of Related Art

A hybrid vehicle that uses at least one of an engine and a motor as a power source has been put in practical use. Such the hybrid vehicle can run solely on the motor like an electric vehicle. Therefore, in some cases, the hybrid vehicle temporarily stops the engine even during the running of the vehicle. Such the operation will be referred to as an intermittent operation, hereafter. A fuel consumption and exhaust gas quantity of the engine are reduced by repeating the intermittent operation of the engine. Thus, air environment protection and fuel consumption improvement are realized,

A catalyst (a catalytic converter) for purifying the exhaust gas discharged from the engine is provided in the hybrid vehicle that uses the engine as one of the power sources. The catalyst removes the emission (i.e., hazardous materials such as HC, CO and NOx) in the exhaust gas.

There is a case where the deterioration of the emission becomes a problem when the intermittent operation of the engine is performed in such the hybrid vehicle. That is, since the catalyst is exposed to an oxygen-excess atmosphere due to the temporal stoppage of the engine, degradation of the catalyst tends to progress. Moreover, when the temporarily-stopped engine is restarted, relatively large quantity of the hazardous materials are contained in the exhaust gas due to incomplete combustion and the like immediately after the restart. In this case, if the function of the catalyst is insufficient, the emission of the exhaust gas discharged to an exterior is deteriorated. For example, JP-A-2004-124827 (Patent document 1) describes a technology for preventing the degradation of the catalyst and the deterioration of the emission of the exhaust gas resulting from the intermittent operation of the engine.

A power output device described in Patent document 1 has an engine, an external power imparting section, an exhaust gas purification section and a control section. The external power imparting section enables an intermittent operation of the engine. The exhaust gas purification section purifies the exhaust gas of the engine with a catalyst. The control section prohibits the intermittent operation of the engine when a purification rate of the catalyst is equal to or lower than a threshold value as control for reducing a hazardous material concentration in the exhaust gas. The purification rate of the catalyst is an index indicating a purification capacity of the catalyst.

The power output device described in Patent document 1 prohibits the intermittent operation of the engine when the purification rate of the catalyst is equal to or lower than the threshold value. Therefore, the progress of the degradation of the catalyst during the stoppage of the engine and the deterioration of the emission at the starting of the engine can be suppressed.

In recent years, a hybrid vehicle that can perform running solely on a motor based on an intention of a driver has been publicly known. Such the hybrid vehicle has a switch (an EV switch) that is operated by the driver when the driver requests the running using only the motor. In such the hybrid vehicle, if the driver switches on the EV switch, normally, the engine is stopped compulsorily and the running solely on the motor is performed on a condition that a certain condition is satisfied.

However, there is no description of the EV switch in the power output device described in Patent document 1. Therefore, Patent document 1 refers to nothing about control in the case where the driver switches on the EV switch (i.e., the driver requests the engine stoppage) while the intermittent operation of the engine is prohibited (i.e., while the engine stoppage is prohibited).

### SUMMARY OF THE INVENTION

It is an object of the present invention to provide a control device and a control method capable of suitably inhibiting deterioration of emission in a hybrid vehicle that runs on power of at least one of an internal combustion engine and a rotating electrical machine.

According to a first example aspect of the present invention, a control device controls a hybrid vehicle running on power of at least one of an internal combustion engine and a rotating electrical machine. The hybrid vehicle is capable of performing an intermittent operation for temporarily stopping the internal combustion engine and is prohibited from performing the intermittent operation when a predetermined condition is satisfied. The control device has an input section, to which a driver inputs an electric running request indicating that the driver requests stoppage of the internal combustion engine and the running using the power of the rotating electrical machine, and a control unit connected to the input section. The control unit operates the internal combustion engine continuously without allowing the electric running request even if the electric running request is inputted when the intermittent operation is prohibited.

According to a second example aspect of the present invention, in the above construction, the control unit does not allow the electric running request even if the electric running request is inputted when the intermittent operation is prohibited in order to reduce hazardous materials in exhaust gas discharged to an outside of the vehicle.

According to a third example aspect of the present invention, in the above construction, the internal combustion engine is connected with a catalyst for purifying exhaust gas of the internal combustion engine. The predetermined condition is a condition that temperature of the catalyst is lower than a certain value. The control unit does not allow the electric running request even if the electric running request is inputted when the temperature of the catalyst is lower than the certain value.

According to a fourth example aspect of the present invention, in the above construction, the control unit allows the electric running request and stops the internal combustion engine if a certain condition is satisfied when the electric running request is inputted in the case where the intermittent operation is not prohibited.

According to a fifth example aspect of the present invention, in the above construction, the control unit informs the driver of a reason of not allowing the electric running request when the control unit does not allow the electric running request.

According to a sixth example aspect of the present invention, a control method is performed by a control unit controlling a hybrid vehicle running on power of at least one of an internal combustion engine and a rotating electrical machine. The hybrid vehicle is capable of performing an intermittent operation for temporarily stopping the internal combustion engine and is prohibited from performing the intermittent operation when a predetermined condition is satisfied. The control unit is connected with an input section, to which a driver inputs an electric running request indicating that the driver requests stoppage of the internal combustion engine and the running using the power of the rotating electrical machine. The control method has the steps of determining whether the electric running request is inputted, determining whether the intermittent operation is prohibited, and operating the internal combustion engine continuously without allowing the electric running request even if the electric running request is inputted when the intermittent operation is prohibited.

According to the present invention, even when the driver requests the running solely on the power of the rotating electrical machine, the electric running request from the driver is not allowed but the internal combustion engine is operated continuously if the intermittent operation of the internal combustion is prohibited. Accordingly, the deterioration of the emission can be suitably inhibited.

### BRIEF DESCRIPTION OF THE DRAWINGS

Features and advantages of an embodiment will be appreciated, as well as methods of operation and the function of the related parts, from a study of the following detailed description, the appended claims, and the drawings, all of which form a part of this application. In the drawings:

FIG. 1 is a diagram showing a structure of a vehicle mounted with a control device according to an embodiment of the present invention;

FIG. 2 is a diagram showing a structure of an engine mounted to the vehicle according to the embodiment;

FIG. 3 is a functional block diagram of the control device according to the embodiment;

FIG. 4 is a first flowchart showing a control structure of the control device according to the embodiment;

FIG. 5 is a second flowchart showing the control structure of the control device according to the embodiment; and

FIG. 6 is a timing chart showing catalyst temperature, engine rotation speed and hydrocarbon generation amount controlled by the control device according to the embodiment,

### DETAILED DESCRIPTION OF EXAMPLE EMBODIMENT

Next, an embodiment of the present invention will be described with reference to the drawings.

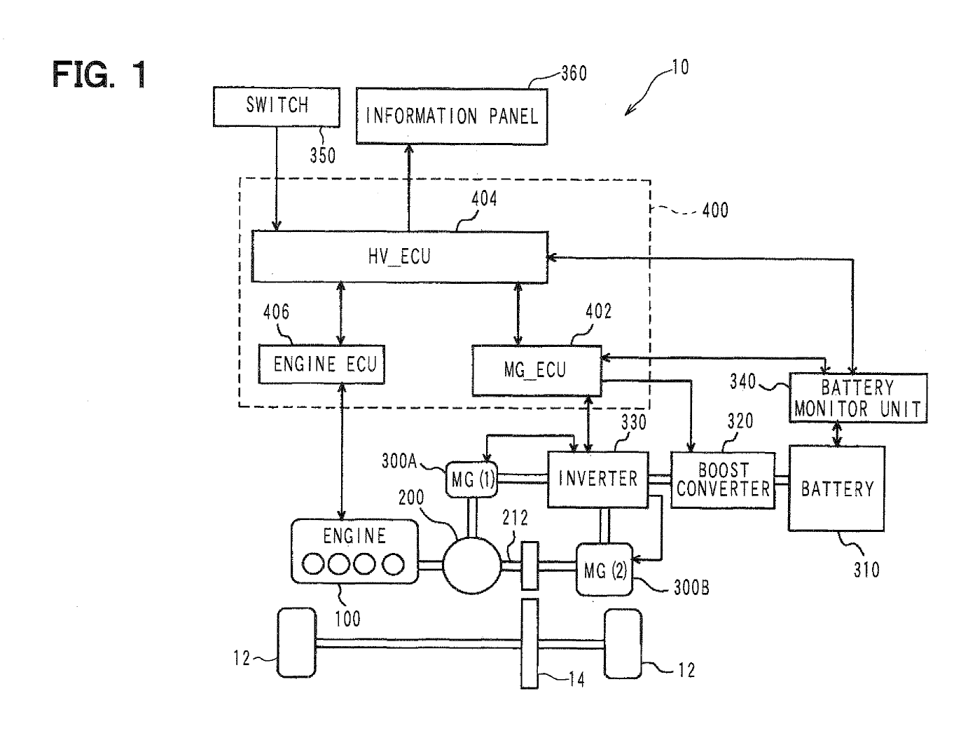

A hybrid vehicle 10 mounted with a control device according to the present embodiment will be explained with reference to FIG. 1. The vehicle, to which the present invention can be applied, is not limited to the hybrid vehicle 10 shown in FIG. 1. The present invention can be also applied to any vehicle having a different construction as long as the vehicle can perform an intermittent operation of an engine during running of the vehicle.

The hybrid vehicle 10 has an engine 100 and motor generators 300A, 300B (MG(1) 300A and MG(2) 300B). In the following description, each of the motor generators 300A, 300B will be referred to also as a motor generator 300 when explanation is given without discriminating between the motor generators 300A, 300B. Regenerative braking is performed when the motor generator 300 functions as a generator. When the motor generator 300 functions as the generator, a kinetic energy of the vehicle is converted into an electric energy and a regenerative braking force (regenerative brake) occurs, and the vehicle is decelerated.

The hybrid vehicle 10 runs on power of at least either one of the engine 100 and the motor generator 300. That is, the hybrid vehicle 10 can run solely on the power of the motor generator 300.

The hybrid vehicle 10 further has a speed reducer 14, a power division mechanism 200, a battery 310, an inverter 330, an engine ECU 406, an MG_ECU 402, an HV_ECU 404, and the like. The speed reducer 14 transmits the power generated in the engine 100 or the motor generator 300 to driving wheels 12 or transmits drive of the driving wheels 12 to the engine 100 or the motor generator 300. The power division mechanism 200 distributes the power generated by the engine 100 to an output shaft 212 and the MG(1) 300A. The battery 310 is charged with an electric power for driving the motor generator 300. The inverter 330 performs current control by converting direct current of the battery 310 and alternating current of the motor generator 300. The engine ECU 406 controls an operation state of the engine 100. The MG_ECU 402 controls a charge-discharge state and the like of the motor generator 300, the inverter 330 and the battery 310 in accordance with a state of the hybrid vehicle 10. The HV_ECU 404 performs mutual management and control with the engine ECU 406, the MG_ECU 402 and the like to control the entire hybrid system such that the hybrid vehicle 10 can run most efficiently.

A boost converter 320 is provided between the battery 310 and the inverter 330. A rated voltage of the battery 310 is lower than a rated voltage of the motor generator 300. Therefore, when the electric power is supplied from the battery 310 to the motor generator 300, the voltage of the electric power is boosted by the boost converter 320.

In FIG. 1, the multiple ECUs are provided as separate bodies. Alternatively, the two or more ECUs may be integrated and provided as a single ECU. For example, as shown by a broken line in FIG. 1, the MG_ECU 402, the HV_ECU 404 and the engine ECU 406 may be integrated into an ECU 400. In the following explanation, the MG_ECU 402, the HV_ECU 404 and the engine ECU 406 will be referred to as the ECU 400 without discriminating therebetween.

Signals are inputted to the ECU 400 from a vehicle speed sensor, an accelerator position sensor a throttle position sensor, an MG(1) rotation speed sensor, an MG(2) rotation speed sensor, an engine rotation speed sensor (which are not shown), and a battery monitor unit 340 that monitors states of the battery 310 such as a voltage value VB between terminals, a battery current value IB and battery temperature TB.

Furthermore, an EV switch 350 and an information panel 360 are connected to the ECU 400.

The EV switch 350 is operated by a driver when the driver requests electric vehicle running (referred to as EV running, hereafter). The EV running is performed using only the motor generator 300 by stopping the engine 100 compulsorily. If the driver switches on the EV switch 350, the EV switch 350 transmits an EV request signal, which indicates that the driver is requesting the EV running, to the ECU 400.

The information panel 360 is provided in a combination meter (not shown) provided in an upper portion of an instrument panel (not shown) of the hybrid vehicle 10. The information panel 360 displays warning information for the driver based on a command from the ECU 400.

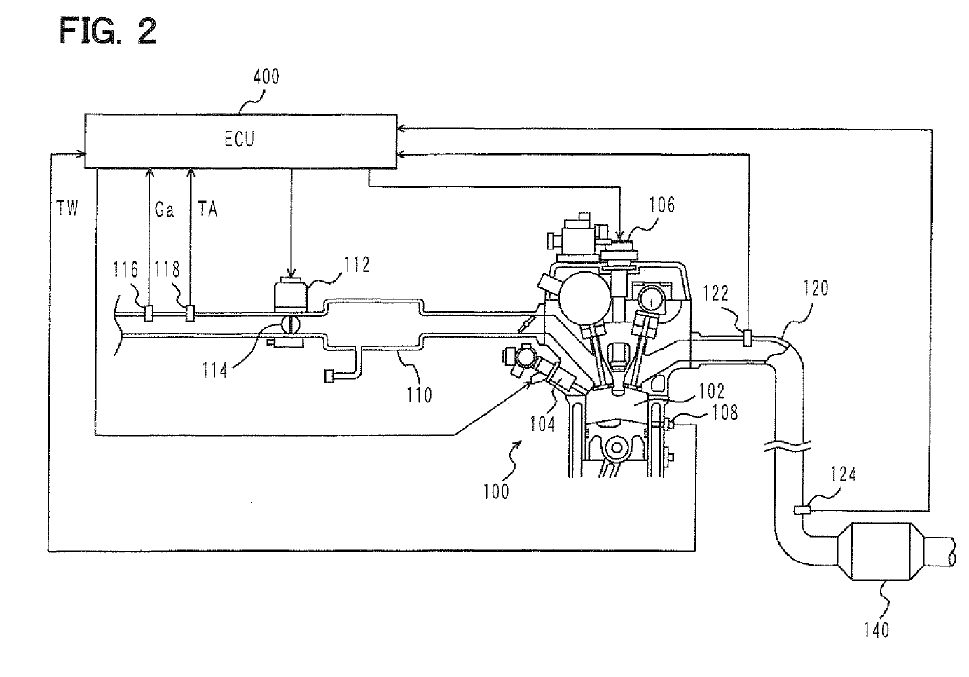

Next, the engine 100 will be explained with reference to FIG. 2. In the engine 100, an air suctioned from an air cleaner (not shown) flows through an intake pipe 110 and is introduced into a combustion chamber 102 of the engine 100. Air quantity introduced into the combustion chamber 102 is adjusted by an opening degree of a throttle valve 114 (i.e., a throttle opening). The throttle opening is controlled by a throttle motor 112 operating based on a signal from the ECU 400.

Fuel is stored in a fuel tank (not shown) and is injected from an injector 104 into the combustion chamber 102 by a fuel pump (not shown). A mixture gas of the air introduced from the intake pipe 110 and the fuel injected from the injector 104 is ignited by an ignition coil 106 and combusted. The ignition coil 106 is controlled by a control signal from the ECU 400.

Exhaust gas after the combustion of the mixture gas passes through a catalyst 140 provided in an exhaust pipe 120 and is discharged to the atmosphere.

The catalyst 140 is a three-way catalyst that performs purification processing of emission (hazardous materials such as hydrocarbon (HC), carbon monoxide (CO) and nitrogen oxides (NOx)) contained in the exhaust gas. Precious metals containing platinum, palladium and rhodium are supported on a base made of alumina in the catalyst 140. The catalyst 140 can cause oxidation reactions of the hydrocarbon and the carbon monoxide and reduction reactions of the nitrogen oxides at the same time. The catalyst 140 has a characteristic that an exhaust gas purification capacity thereof increases as temperature thereof increases.

Signals are inputted to the ECU 400 from an engine coolant temperature sensor 108, an airflow meter 116, an intake temperature sensor 118, an air-fuel ratio sensor 122 and an oxygen sensor 124.

The engine coolant temperature sensor 108 senses temperature TW of an engine coolant (i.e., engine coolant temperature TW). The airflow meter 116 is provided upstream of the throttle valve 114 in the intake pipe 110. The airflow meter 116 senses intake air quantity Ga, i.e., air quantity suctioned by the engine 100 per unit time. The intake temperature sensor 118 senses temperature TA of the intake air (i.e., intake air temperature TA). The air-fuel ratio sensor 122 senses a ratio between the air and the fuel in the exhaust gas. The oxygen sensor 124 senses an oxygen concentration in the exhaust gas. These sensors transmit the signals indicating the sensing results to the ECU 400.

The ECU 400 controls devices to realize a desired running state of the hybrid vehicle 10 based on the signals sent from the respective sensors and based on maps and programs stored in ROM (Read Only Memory).

For example, the ECU 400 controls the ignition coil 106 to achieve proper ignition timing and controls the throttle motor 112 to achieve a proper throttle opening based on the signals from the sensors.

The ECU 400 controls the injector 104 to achieve proper fuel injection quantity based on the signals from the sensors. The ECU 400 performs feedback control of the fuel injection quantity based on the signals from the air-fuel ratio sensor 122 and the oxygen sensor 124 such that the air-fuel ratio becomes a proper value.

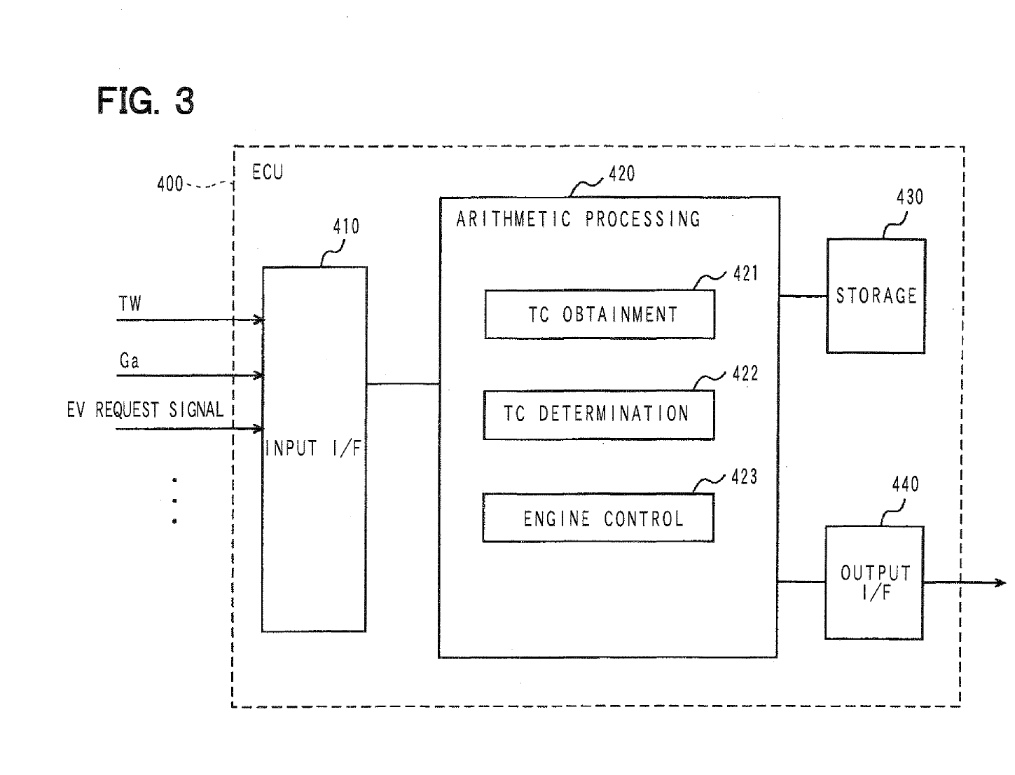

FIG. 3 is a functional block diagram showing the ECU 400 as a control device according to the present embodiment. The ECU 400 has an input interface 410, an arithmetic processing section 420, a storage section 430 and an output interface 440.

The input interface 410 receives the engine coolant temperature TW from the engine coolant temperature sensor 108, the intake air quantity Ga from the airflow meter 116, the EV request signal from the EV switch 350 and the sensing results from the other sensors and transmits them to the arithmetic processing section 420.

The storage section 430 stores various kinds of information, programs, threshold values, maps and the like. The data are read from and stored in the storage section 430 by the arithmetic processing section 420 when needed.

The arithmetic processing section 420 has a catalyst temperature obtaining section 421, a catalyst temperature determination section 422 and an engine control section 423.

The catalyst temperature obtaining section 421 obtains temperature TC of the catalyst 140 (i.e., catalyst temperature TC). The catalyst temperature obtaining section 421 estimates the catalyst temperature TC based on parameters having close relationship with the temperature of the catalyst 140 (for example, the engine coolant temperature TW, an integration value of the intake air quantity Ga, the engine rotation speed NE and the like).

For example, the catalyst temperature obtaining section 421 estimates a soak time based on the engine coolant temperature TWst as of the starting of the vehicle. The soak time is time from the previous stoppage to the present starting. The catalyst temperature obtaining section 421 estimates the catalyst temperature TCst as of the starting of the vehicle in accordance with the soak time and stores the catalyst temperature TCst in the storage section 430. Furthermore, the catalyst temperature obtaining section 421 calculates an integration value of the intake air quantity Ga after the starting of the vehicle and estimates catalyst temperature increase amount ΔTC after the starting of the vehicle based on the integration value. The catalyst temperature obtaining section 421 estimates the catalyst temperature TC by adding the catalyst temperature increase amount ΔTC to the catalyst temperature TCst as of the starting of the vehicle (i.e., TC=TCst+ΔTC). The estimation method of the catalyst temperature TC is not limited to the above method. If a sensor capable of directly sensing the temperature of the catalyst 140 is provided a sensor output value of the sensor may be obtained as the catalyst temperature TC.

The catalyst temperature determination section 422 determines whether the catalyst temperature TC is lower than a predetermined threshold value. The threshold value is set based on the catalyst temperature necessary for the exhaust gas purification at the starting of the engine.

The engine control section 423 selects an operation mode of a normal operation or an operation mode of an intermittency prohibition operation, which is referred to also as an intermittency prohibition operation for emission deterioration prevention, based on the determination result of the catalyst temperature determination section 422. The normal operation allows the intermittent operation of the engine 100. The intermittency prohibition operation prohibits the intermittent operation of the engine 100 to prevent the emission deterioration. The engine control section 423 transmits control signals for controlling the engine 100 in the selected operation mode to respective devices such as the ignition coil 106, the throttle motor 112 and the injector 104.

When the catalyst temperature TC is lower than the predetermined threshold value, the engine control section 423 determines that the purification capacity of the catalyst 140 has not reached the capacity necessary for the exhaust gas purification at the starting of the engine and selects the intermittency prohibition operation.

When the catalyst temperature TC is higher than the predetermined threshold value, the engine control section 423 determines that the purification capacity of the catalyst 140 has reached the capacity necessary for the exhaust gas purification at the starting of the engine and selects the normal operation for allowing the intermittent operation.

Furthermore, the engine control section 423 determines whether to allow the EV running request from the driver (i.e., the EV request signal from the EV switch 350) in accordance with the operation mode of the engine 100.

During the normal operation, the engine control section 423 allows the EV running request from the driver and stops the engine 100 on a condition that a certain condition is satisfied. The certain condition is a condition that vehicle speed is lower than a certain value (i.e., a fuel consumption efficiency of the engine 100 is low) and SOC of the battery 310 is higher than a certain value (i.e., the battery 310 can supply sufficient power to the motor generator 300), for example.

During the intermittency prohibition operation for the emission deterioration prevention, the engine control section 423 does not allow the EV running request from the driver (i.e., cancels the EV request signal) and operates the engine 100 continuously.

The explanation of the present embodiment is given on the assumption that the catalyst temperature obtaining section 421, the catalyst temperature determination section 422 and the engine control section 423 function as software, which is realized when CPU as the arithmetic processing section 420 executes the programs stored in the storage section 430. Alternatively, the catalyst temperature obtaining section 421, the catalyst temperature determination section 422 and the engine control section 423 may be realized with hardware. Such the programs are recorded on a storage medium and mounted in the vehicle.

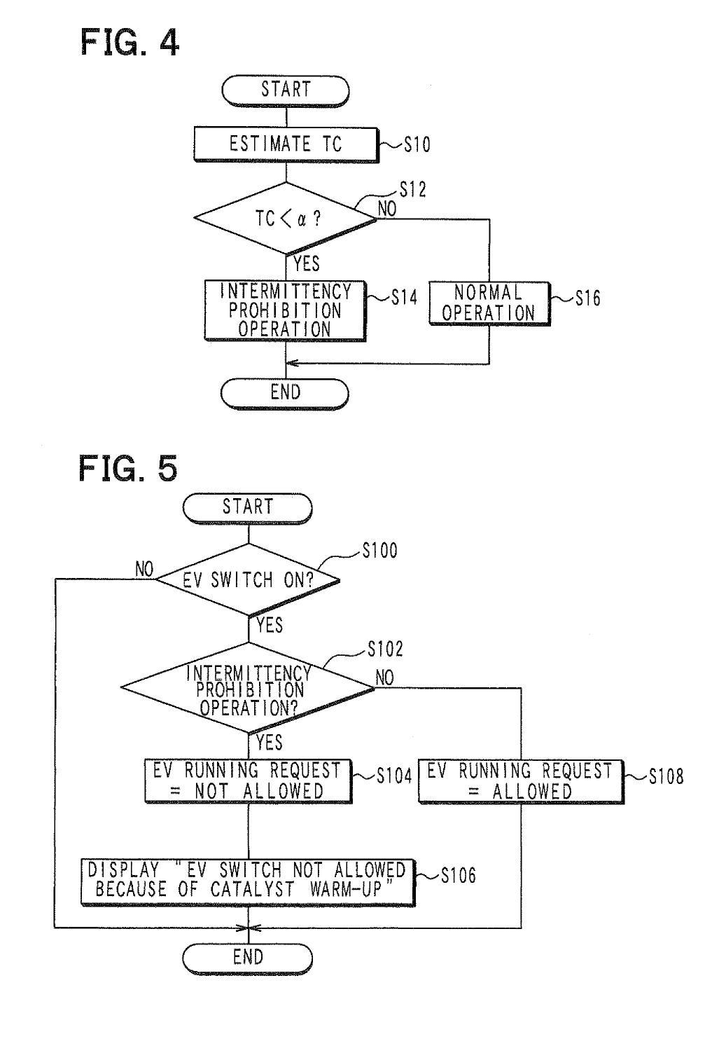

Hereafter, control structure of a program executed by the ECU 400, which is the control device according to the present embodiment, will be explained with reference to FIG. 4. The program is repeatedly executed in a predetermined time cycle.

The ECU 400 obtains the catalyst temperature TC in S10 (S means “Step”). For example, as mentioned above, the ECU 400 estimates the catalyst temperature TC based on the engine coolant temperature TW and the intake air quantity Ga.

In S12, the ECU 400 determines whether the catalyst temperature TC is lower than a predetermined threshold value α. If it is determined that the catalyst temperature TC is lower than the threshold value α (S12: YES), the processing is shifted to S14. Otherwise (S12: NO), the processing is shifted to S16.

In S14, the ECU 400 performs the intermittency prohibition operation for the emission deterioration prevention. As mentioned above, the intermittent operation of the engine 100 is prohibited during the intermittency prohibition operation for the emission deterioration prevention. In this case, in order to warm up the catalyst 140 quickly, the fuel injection quantity to the engine 100 may be increased from the fuel injection quantity of the normal operation.

In S16, the ECU 400 performs the normal operation. During the normal operation, as mentioned above, the intermittent operation of the engine 100 is allowed. That is, the engine 100 is stopped every time a certain condition (e.g., a condition that SOC of the battery 310 is higher than a predetermined value) is satisfied, and the engine 100 is started every time the certain condition stops being satisfied.

Hereafter, control structure of a program executed by the ECU 400, which is the control device according to the present embodiment, will be explained with reference to FIG. 5. The program is repeatedly executed in a predetermined time cycle.

In S100, the ECU 400 determines whether the driver has requested the EV running (i.e., whether the EV request signal has been received from the EV switch 350). If the EV request signal is received (S100: YES), the processing is shifted to S102. Otherwise (S100 NO), the processing ends.

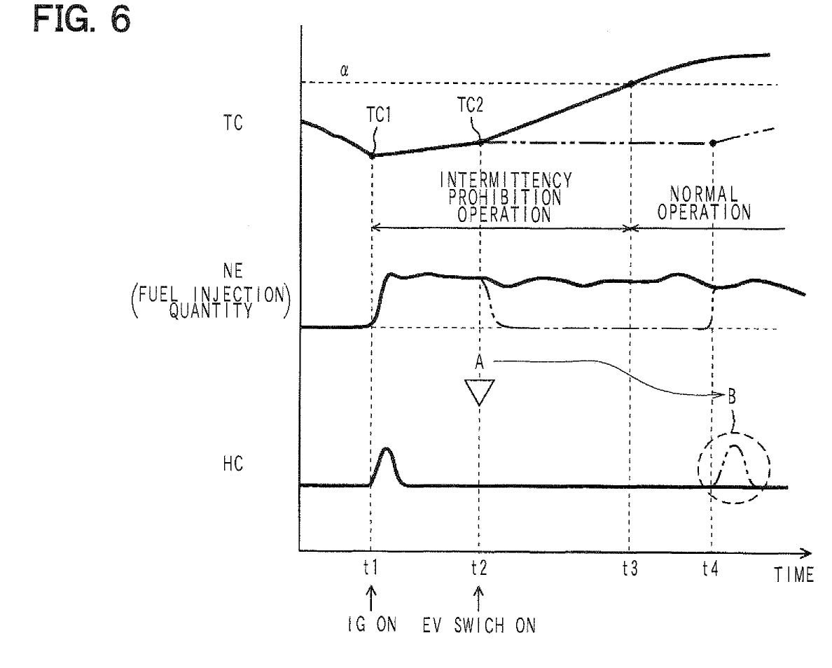

In S102, the ECU 400 determines whether the intermittency prohibition operation for the emission deterioration prevention is in progress (i.e., whether the processing of S14 of FIG. 6 is in execution). If it is determined that the intermittency prohibition operation for the emission deterioration prevention is in progress (S102: YES), the processing is shifted to S104. Otherwise (S102: NO), the processing is shifted to S108.

In S104, the ECU 400 does not allow the EV running request from the driver (i.e., cancels the EV request signal) and operates the engine 100 continuously.

In S106, the ECU 400 informs the driver of the fact and the reason of not performing the EV running. For example, the ECU 400 displays “EV running is not allowed because of catalyst warm-up” on the information panel 360.

In S108, the ECU 400 allows the EV running request from the driver and stops the engine 100 on a condition that a certain condition is satisfied. Thus, the hybrid vehicle 10 runs on the power of only the motor generator 300.

Next, an operation of the ECU 400, which is the control device according to the present embodiment, based on the structure and the flowchart described above will be explained with reference to FIG. 6.

FIG. 6 is a timing chart showing the catalyst temperature TC, the engine rotation speed NE and generation amount of the hydrocarbon (HC) in the case where the driver switches on an ignition switch (IG ON) to start the hybrid vehicle at time t1. The engine rotation speed NE in FIG. 6 corresponds to the fuel injection quantity supplied to the engine 100.

As shown in FIG. 6, since the catalyst temperature TC1 at the time ti is lower than the threshold value α (S12: YES), the intermittency prohibition operation for the emission deterioration prevention is performed (S14).

The driver switches on the EV switch 350 at time t2 (S100: YES) in the example of FIG. 6. The catalyst temperature TC2 at the time t2 is still lower than the threshold value α, and the intermittency prohibition operation for the emission deterioration prevention is performed at the time t2.

If the EV running is performed (i.e., if the engine 100 is stopped) in such the state in response to the request from the driver, the engine 100 is stopped and the catalyst temperature TC is maintained at a value lower than the threshold value a (i.e., substantially at the catalyst temperature TC2 at the time t2) as shown by a chain double-dashed line in FIG. 6. Therefore, when the driver switches off the EV switch 350 to restart the engine 100 at later time t4, the purification capacity of the catalyst 140 has not reached the capacity necessary for the exhaust gas purification at the starting of the engine 100. Accordingly, large quantity of the HC component generated at the restart cannot be fully purified with the catalyst 140.

In contrast, in the present embodiment, even if the driver switches on the EV switch at the time t2 (S100: YES), the EV running request from the driver is not allowed (S104) but the engine 100 is operated continuously when the intermittency prohibition operation for the emission deterioration prevention is in progress (S102: YES).

Thus, even if the driver requests the EV running by switching on the EV switch 350, the request is not allowed (at timing A in FIG. 6) during the intermittency prohibition operation for the emission deterioration prevention. Therefore, the above-mentioned problem that the engine 100 is restarted in the state where the purification capacity of the catalyst 140 is insufficient can be precluded. In the example of FIG. 6, the generation of HC conventionally occurring when the EV running ends (i.e., when the engine is restarted) is reduced as shown by an area B in FIG. 6.

Thus, even if the driver requests the EV running by switching on the EV switch, the control device according to the present embodiment does not allow the request when the intermittency prohibition operation for the emission deterioration prevention is in progress. Therefore, the problem that the engine is restarted in the state where the purification capacity of the catalyst is insufficient can be precluded. Thus, the deterioration of the emission can be suitably inhibited.

In the above-described embodiment, it is determined whether to allow the EV running request from the driver based on whether the intermittency prohibition operation for the emission deterioration prevention is in progress. Alternatively, the determination may be performed directly based on the catalyst temperature TC. That is, a construction that the EV running request from the driver is not allowed when the catalyst temperature TC is lower than the threshold value and the EV running request from the driver is allowed when the catalyst temperature TC is higher than the threshold value may be employed.

While the invention has been described in connection with what is presently considered to be the most practical and preferred embodiments it is to be understood that the invention is not to be limited to the disclosed embodiments, but on the contrary, is intended to cover various modifications and equivalent arrangements included within the spirit and scope of the appended claims.

What is claimed is:

1. A control device of a hybrid vehicle running on power of at least one of an internal combustion engine and a rotating electrical machine, wherein the hybrid vehicle is capable of performing an intermittent operation for temporarily stopping the internal combustion engine and is prohibited from performing the intermittent operation when a predetermined condition is satisfied, the control device comprising:
an input section, to which a driver inputs an electric running request indicating that the driver requests stoppage of the internal combustion engine and the running using the power of the rotating electrical machine; and
a control unit connected to the input section, wherein
the control unit operates the internal combustion engine continuously without allowing the electric running request even if the electric running request is inputted when the intermittent operation is prohibited.

2. The control device as in claim 1, wherein
the control unit does not allow the electric running request even if the electric running request is inputted when the intermittent operation is prohibited in order to reduce hazardous materials in exhaust gas discharged to an outside of the vehicle.

3. The control device as in claim 1, wherein
the internal combustion engine is connected with a catalyst for purifying exhaust gas of the internal combustion engine,
the predetermined condition is a condition that temperature of the catalyst is lower than a certain value, and
the control unit does not allow the electric running request even if the electric running request is inputted when the temperature of the catalyst is lower than the certain value.

4. The control device as in claim 1, wherein
the control unit allows the electric running request and stops the internal combustion engine if a certain condition is satisfied when the electric running request is inputted in the case where the intermittent operation is not prohibited.

5. The control device as in claim 1, wherein
the control unit informs the driver of a reason of not allowing the electric running request when the control unit does not allow the electric running request.

6. A control method performed by a control unit controlling a hybrid vehicle running on power of at least one of an internal combustion engine and a rotating electrical machine, wherein the hybrid vehicle is capable of performing an intermittent operation for temporarily stopping the internal combustion engine and is prohibited from performing the intermittent operation when a predetermined condition is satisfied and wherein the control unit is connected with an input section, to which a driver inputs an electric running request indicating that the driver requests stoppage of the internal combustion engine and the running using the power of the rotating electrical machine, the control method comprising the steps of:
determining whether the electric running request is inputted;
determining whether the intermittent operation is prohibited; and
operating the internal combustion engine continuously without allowing the electric running request even if the electric running request is inputted when the intermittent operation is prohibited.
